(19) United States
(12) Patent Application Publication
(10) Pub. No.: US 2014/0144658 A1
(43) Pub. Date: May 29, 2014

(54) PERCUSSION MECHANISM APPARATUS

(71) Applicants: Lars Schmid, Nuertingen (DE); Johannes Schnitzler, Reutlingen (DE); Jan Koalick, Leinfelden-Echterdingen (DE)

(72) Inventors: Lars Schmid, Nuertingen (DE); Johannes Schnitzler, Reutlingen (DE); Jan Koalick, Leinfelden-Echterdingen (DE)

(73) Assignee: Robert Bosch GmbH, Stuttgart (DE)

(21) Appl. No.: 14/130,924

(22) PCT Filed: Jun. 13, 2012
(86) PCT No.: PCT/EP2012/061170

§ 371 Date: Jan. 4, 2014

(30) Foreign Application Priority Data
Jul. 5, 2011 (DE) 10 2011 078 628.7

(51) Int. Cl. B25D 17/06

(52) U.S. Cl. CPC B25D 17/06
USPC 173/90

(57) ABSTRACT

A percussion mechanism apparatus, in particular for a rotary and/or demolition hammer, includes at least one striker, at least one percussion pin with at least one guide lug that faces the striker, and at least one movably mounted control disc arranged around the guide lug. The guide lug has at least one end that projects beyond the control disc in every operating state.

### PRIOR ART

There are already known striking mechanism devices, in particular for hammer drills and/or chipping hammers, that comprise a striker, a striking pin, which has a guide lug facing toward the striker, and a movably mounted control disc, which is disposed around the guide lug.

### DISCLOSURE OF THE INVENTION

The invention proceeds from a striking mechanism device, in particular for a hammer drill and/or chipping hammer, having at least one striker, having at least one striking pin, which has at least one guide lug facing toward the striker, and having at least one movably mounted control disc, which is disposed around the guide lug.

It is proposed that one end of the guide lug project beyond the control disc in each operating state. The term “striking mechanism device” is to be understood here to mean, in particular, a device having at least one component that is provided to generate and/or transmit an impulse, in particular an axial striking impulse, to a working tool disposed in a tool receiver.

Such a component may be, in particular, a striker, a striking pin, a guide element such as, in particular, a hammer tube and/or a piston such as, in particular, a hollow piston, and/or other components considered appropriate by persons skilled in the art. “Provided” is to be understood to mean, in particular, specially designed and/or specially equipped. The expression “striker” is intended here to define, in particular, a component that is moved for the purpose of transmitting a striking pulse to a further component of the striking mechanism device, in particular to the striking pin, within a guide element, in particular within a hammer tube and/or a hollow piston. Preferably, for the purpose of generating a striking impulse, the striker is moved within the guide element by means of a pressure, in particular by means of an air pressure generated by means of a piston guided in the hammer tube. Preferably, the striker is disposed, along a striking direction, between a piston and the striking pin and/or a tool. The term “striking pin” is intended here to define, in particular, a component provided to transmit to a working tool disposed is a tool receiver, as a result of a direct contact, a striking pulse transmitted from the striker to the component. A “control” disc is to be understood here to mean, in particular, a component provided to move a control sleeve, for the purpose of controlling a pressure in the guide element, as a result of a movement of the striking pin. Preferably, by means of a movement of the control sleeve by the control disc, control openings in the guide element are opened and/or closed in a manner already known to persons skilled in the art. Preferably, for the purpose of moving the control disc, the striking pin has control extensions, which are provided to move the control disc in a direction oriented contrary to a striking direction of the striker.

The expression “guide lug” is intended ere to define, in particular, a region of the striking pin on which the control disc is at least partially guided. The control disc in this case preferably comprises a recess, in which the guide lug of the striking pin is disposed, in particular engages. Preferably, the guide lug is realized in the form of a cylinder. The guide lug therefore has a round cross section, particularly preferably in a plane running at least substantially perpendicularly in relation to a striking direction of the striker. It is also conceivable, however, for the guide lug to be of a different design, considered appropriate by persons skilled in the art, and/or to have a different cross section, considered appropriate by persons skilled in the art, such as, for example, an elliptical cross section, a polygonal cross section, etc. The expression “substantially perpendicularly” is intended here to define, in particular, an alignment of a direction relative to a reference direction, the direction and the relative direction, in particular as viewed in one plane, enclosing an angle of 90° and the angle having a maximum deviation of, in particular, less than 8°, advantageously less than 5°, and particularly advantageously less than 2°. “Project in each operating state” is to be understood here to mean, in particular, a disposition of the guide lug, in all operating states, that can be assumed by the guide lug, when in a mounted state, during operation, the guide lug at each instant and/or in each position, when in a mounted state, extending by one end, as viewed along a direction running contrary to a striking direction of the striker, beyond at least one outer face of the control disc that faces toward the striker. Preferably, the guide lug, as viewed along a direction running contrary to a striking direction of the striker, extends through the recess of the control disc, and therefore beyond the outer face. Precise guidance of the control disc can be achieved, advantageously, by means of the striking mechanism device according to the invention. In addition, it is possible to prevent striking impulses, that could damage the control disc, from being transmitted to the control disc via the guide lug. Advantageously, therefore, damage to the control disc can be prevented. In this case, advantageously, it is possible to achieve a long service life of the components of the striking mechanism device according to the invention.

It is furthermore proposed that, in each operating state, the guide lug project, by the end that faces toward the striker, at least by more than 0.1 mm beyond the control disc, along a direction oriented contrary to a striking direction of the striker. Preferably, the guide lug projects, by the end, at least by more than 0.5 mm beyond the control disc, and particularly preferably at least by more than 1 mm. It is advantageously possible to prevent the guide lug from being moved out of the recess of the control disc in the case of a striking movement in the direction of a working tool disposed in a tool receiver.

Preferably, the guide lug, along a striking direction of the striker, has an axial extent that is at least greater than 25% of a total extent of the striking pin. Preferably, the guide lug, along a striking direction of the striker, has an axial extent that is at least greater than 30% of a total extent of the striking pin, and particularly preferably at least greater than 33% of a total extent of the striking pin. Moreover, the guide lug has an axial extent that is preferably longer than an idling path of the striking pin in the guide element. When the striking pin is in a mounted state, the total extent of the striking pin is at least substantially parallel to the striking direction of the striker. “Substantially parallel” is to be understood here to mean, in particular, an alignment of a direction relative to a reference direction, in particular in one plane, the direction deviating from the reference direction by, in particular, less than 8°, advantageously less than 5°, and particularly advantageously less than 2°. By means of the shape of the guide lug according to the invention, it can be ensured through simple design means that the guide lug, in each operating state, projects beyond the control disc, along a direction oriented contrary to a striking direction of the striker.

It is additionally proposed that the striker, at an end of the striker that faces toward the guide lug, have at least one insertion recess, which is provided to enable the guide lug to be inserted as the striker approaches the striking pin. The insertion recess, preferably, in a plane running at least substantially perpendicularly in relation to a striking direction of the striker, has a cross section corresponding to a cross section of the guide lug. The insertion recess in this case may be constituted by a through-hole, which is closed, for example, on a side of the striker that faces away from the striking pin, by means of a membrane, which ensures that the striker can be moved within the guide element by means of a pressure, in particular by means of an air pressure. It is also conceivable, however, for the insertion recess to be of a different design, considered appropriate by persons skilled in the art. Through simple design means, the striking pin and the striker can be implemented in an already existing striking mechanism device.

Advantageously, the insertion recess is constituted by a blind hole. Particularly advantageously, therefore, it is possible to maintain actuation of the striker by means of a pressure, in particular by means of an air pressure, for the purpose of generating and/or transmitting a striking impulse. Moreover, insertion of the guide lug into the striker can be delimited through simple design means.

It is furthermore proposed that the insertion recess be of a depth that, along a direction oriented contrary to a striking direction of the striker, is at least greater than 10% of a total extent of the striker. Preferably, the insertion recess is of a depth that, along a direction oriented contrary to a striking direction of the striker, is at least greater than 15% of a total extent of the striker, and particularly preferably at least greater than 20% of a total extent of the striker. The total extent of the striker, when in a mounted state, is preferably at least substantially parallel to a striking direction of the striker. A “depth” is to be understood here to mean, in particular, a maximum distance along a striking direction of the striker, between an outer face of the striker that faces toward the striking pin and a delimiting wall of the striker that delimits the insertion recess and extends at least substantially perpendicularly in relation to a striking direction of the striker. The design of the insertion recess according to the invention makes it possible, advantageously, to achieve a long movement distance of the striker for the purpose of generating a striking impulse.

The invention additionally proceeds from a portable power tool, in particular a hammer drill and/or chipping hammer, having a striking mechanism device according to the invention. A “portable power tool” is to be understood here to mean, in particular, a power tool for performing work on workpieces, which power tool can be transported by an operator without a transport machine. The portable power tool has, in particular, a mass of less than 40 kg, preferably less than 10 kg, and particularly preferably less than 5 kg. Advantageously, for an operator of the portable power tool, a high degree of operating comfort can be achieved.

The striking mechanism device according to the invention and/or the portable power tool according to the invention are not intended in this case to be limited to the application and embodiment described above. In particular, the striking mechanism device according to the invention and/or the portable power tool according to the invention may have individual elements, components and units that differ in number from a number stated herein, in order to fulfill a principle of function described herein.

### DRAWING

Further advantages are given by the following description of the drawing. The drawing shows an exemplary embodiment of the invention. The drawing, the description and the claims contain numerous features in combination. Persons skilled in the art will also expediently consider the features individually and combine them to create appropriate further combinations.

In the drawing:

FIG. 1 shows a portable power tool according to the invention, which has a striking mechanism device according to the invention, in a schematic representation,

FIG. 2 shows a detail view of the striking mechanism device according to the invention, in a schematic representation,

FIG. 3 shows a detail view of a striker of the striking mechanism device according to the invention, in a schematic representation, and

FIG. 4 shows a detail view of a striking pin of the striking mechanism device according to the invention, in a schematic representation.

### DESCRIPTION OF THE EXEMPLARY EMBODIMENT

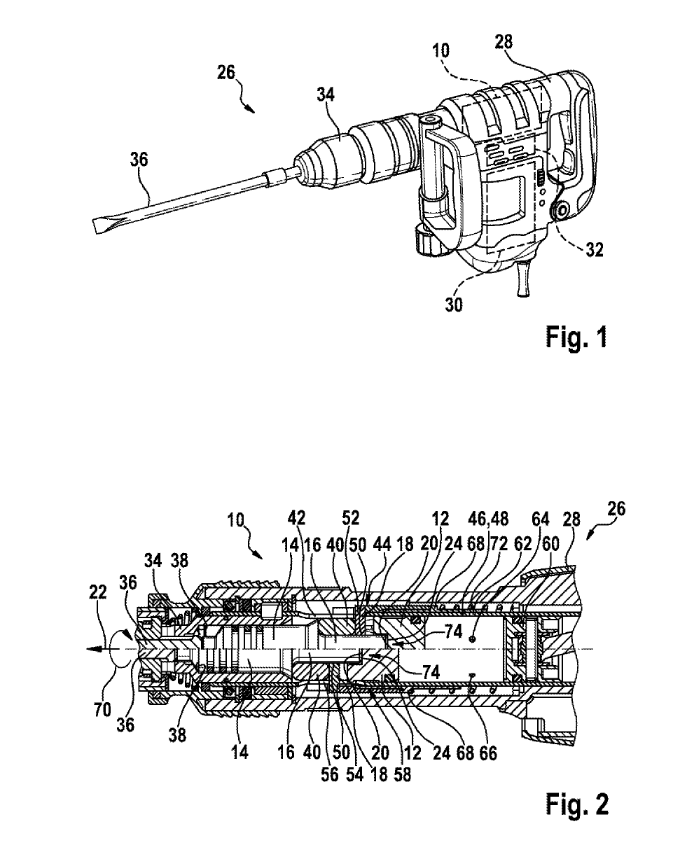

FIG. 1 shows a portable power tool 26, which as a striking mechanism device 10. The portable power tool is realized as a hammer drill and/or chipping hammer. It is also conceivable, however, for the portable power tool 26 to be of a different design, considered appropriate by persons skilled in the art, such as, for example, as an impact wrench, percussion hammer, etc. The portable power tool 26 comprises a power-tool housing 28, which encloses a drive unit 30 and a transmission unit 32 of the portable power tool 26. The drive unit 30 is provided to generate a driving torque, in a manner already known to persons skilled in the art. The driving torque of the drive unit 30 is transmitted to the striking mechanism device 10, via the transmission unit 32, for the purpose of generating a striking impulse and, for the purpose of generating a rotary motion of a working tool 36 disposed in a tool receiver 34 of the portable power tool 26, is transmitted to the tool receiver 34 via a guide element 46 (FIG. 2). The striking impulse of the striking mechanism device 10 in this case is generated in a manner known to persons skilled in the art.

FIG. 2 shows the striking mechanism device 10, partially with a striking pin 14 of the striking mechanism device 10 in a rear end position and partially with the striking pin 14 in a front end position. In a rear end position, the striking pin 14 is supported, via a damping element 40 of the striking mechanism device 10, on a movably mounted control disc 18 of the striking mechanism device 10 that bears against two edge regions 44, 58 of a guide element 46 of the striking mechanism device 10 that face away from the tool receiver 34 and that each delimit a recess 42, 56. The damping element 40 is provided to damp striking-pin rebound shocks. The recesses 42, 56 of the guide element 46 are provided to enable the control disc 18 to move axially along and contrary to a striking direction 22 of a striker 12 of the striking mechanism device 10, in the guide element 46. The guide element 46 in this case is realized as a hammer tube 48, which guides the striking pin 14 and the striker 12 axially when a striking impulse is being generated and/or transmitted. In the front end position, the striking pin 14 bears against an inclined face 38 of the tool receiver 34, which delimits a possible movement of the striking pin 14 in the direction of the working tool 36 disposed in the tool receiver 34. The striking mechanism device 10 thus comprises the striker 12, the striking pin 14, which has a guide lug 16 facing towards the striker 12, and the movably mounted control disc 18, which is disposed around the guide lug 16. The control disc 18 in this case comprises a recess 50, in which the guide lug 16 of the striking pin 14 is disposed when in a mounted state. The recess 50 is circular in form, a central axis of the control disc 18 constituting a central point of the recess 50. The central axis is at least substantially parallel to the striking direction 22 of the striker 12. The control disc 18 in this case has an annular shape, which comprises two guide extensions 52, 54 that extend at least substantially radially. The guide extensions 52, 54 are provided to guide the control disc 18 in the recesses 42, 56. It is also conceivable, however, for the control disc 18 to be of a different shape, considered appropriate by persons skilled in the art, such as, for example, a polygonal shape, in which case, for example, corners are disposed in the recesses 42, 56 for the purpose of guidance.

When the control disc 18 and the striking pin 14 are in a mounted state, an end 20 of the guide lug 16 projects beyond the control disc 18, along a direction oriented contrary to the striking direction 22, in each operating state. The guide lug 16, when in a mounted state, thus extends through the recess 50 of the control disc 18, along the direction oriented contrary to the striking direction 22, in each operating state. The guide lug 16 in this case projects, by the end 20 that faces toward the striker 12, by more than 0.1 mm beyond the control disc 18, along the direction oriented contrary to a striking direction 22 of the striker 12, in each operating state. To enable the guide lug 16 to project out in each operating state, the guide lug 16, along the striking direction 22 of the striker 12, has an axial extent that is at least greater than 25% of a total extent of the striking pin 14 along the striking direction 22 of the striker 12 (cf. also FIG. 4). The guide lug 16 has a cylindrical shape. The guide lug 16 therefore has a circular cross section in a plane running at least substantially perpendicularly in relation to a striking direction 22 of the striker 12.

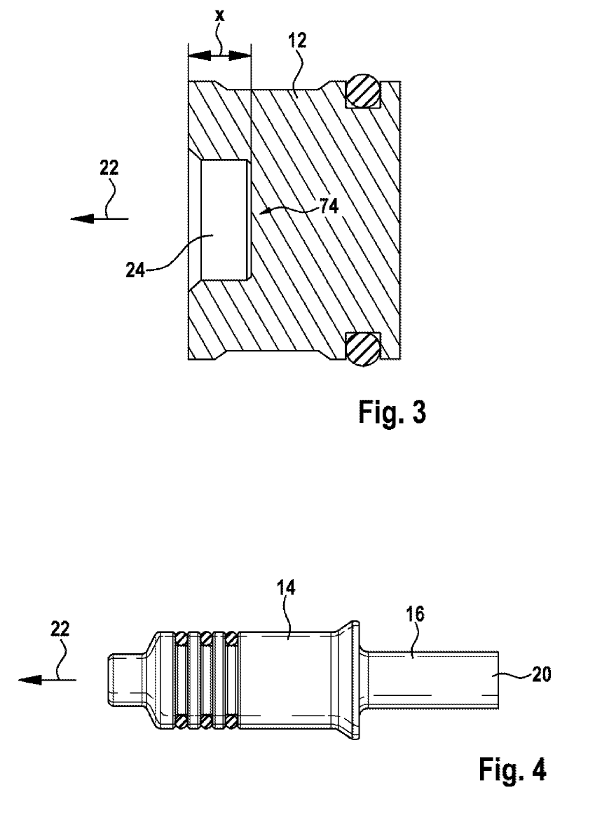

Furthermore, the striker 12, at an end of the striker 12 that faces toward the guide lug 16, has an insertion recess 24, which is provided to enable the guide lug 16 to be inserted as the striker 12 approaches the striking pin 14. The insertion recess 24 is constituted by a blind hole (cf. also FIG. 3). The insertion recess 24 in this case is of a depth x, which, along the direction oriented contrary to the striking direction 22 of the striker 12, is at least greater than 10% of a total extent of the striker 12 along the direction oriented contrary to the striking direction 22 of the striker 12 (FIG. 3). The insertion recess 24, in the plane running at least substantially perpendicularly in relation to the striking direction 22 of the striker 12, has a cross section corresponding to the circular cross section of the guide lug 16. It is also conceivable, however, for the insertion recess 24 to have a different cross section, considered appropriate by persons skilled in the art. The insertion recess 24 in this case, along a direction running at least substantially perpendicularly in relation to the striking direction 22 of the striker 12, is of a greater dimension than the guide lug 16. A clearance fit is thus provided for the guide lug 16 in the insertion recess 24.

During generation of a striking impulse, the striker 12 is moved in the hammer tube 48, in the direction of the striking pin 14, by means of an air cushion compressed in the hammer tube 48 by a piston 60 of the striking mechanism device 10, in a manner already known to persons skilled in the art. In this case, air control openings 62, 64, 66 of the hammer tube 48 are closed by a control sleeve 68 of the striking mechanism device 10 for the purpose of building up a pressure (see upper part of FIG. 2). The control sleeve 68 surrounds the hammer tube 48 along a circumferential direction 70 that extends at least substantially perpendicularly in relation to the striking direction 22 of the striker 12. In addition, a spring force is applied to the control sleeve 68 by means of a spring element 72 of the striking mechanism device 10, in the direction of the tool receiver 34. After the working tool 36 disposed in the tool receiver 34 has been pressed on to a workpiece (not represented in greater detail here), the striking pin 14 is in the rear end position. As a result of the working tool 36 having been pressed on to the workpiece, the control sleeve 68 is pushed, via the striking pin 14, the damping element 40 and the control sleeve 18, against a spring force of the spring element 72, in a manner already known to persons skilled in the art, over the air control openings 62, 64, 66, in order to close the air control openings 62, 64, 66. A pressure can therefore be generated to move the striker 12 in the hammer tube 48. The striker 12, when moving in the hammer tube 48, is moved, by means of the air cushion compressed by the piston 60, in the direction of the striking pin 14 until a base region 74 of the striker 12 that delimits the insertion recess 24 comes into direct contact with the guide lug 16. As a result of this, a striking impulse is transmitted to the striking pin 14, which consequently moves in the direction of the tool receiver 34 and transmits the striking pulse to the working tool 36 disposed in the tool receiver 34. The end 20 of the guide lug 16 in this case always projects over the control disc 18. The control sleeve 68 is likewise moved in the direction of the tool receiver 34, by means of a spring force of the spring element 72. As a result of this, the air control openings 62, 64, 66 are opened, and a sequence for generating a striking impulse by means of the striking mechanism device 10 can recommence, as described above and in a manner already known to persons skilled in the art.

1. A striking mechanism device, comprising:
at least one striker;
at least one striking pin having at least one guide lug facing toward the striker; and
at least one movably mounted control disc disposed around the guide lug,
wherein one end of the guide lug projects beyond the control disc in each operating state.

2. The striking mechanism device as claimed in claim 1, wherein, in each operating state, the end of the guide lug that faces toward the striker, projects at least by more than 0.1 mm beyond the control disc along a direction oriented contrary to a striking direction of the striker.

3. The striking mechanism device as claimed in claim 1, wherein the guide lug has an axial extent that is at least greater than 25% of a total extent of the striking pin along a striking direction of the striker.

4. The striking mechanism device as claimed in claim 1, wherein the striker, at an end of the striker that faces toward the guide lug, has at least one insertion recess configured to enable the guide lug to be inserted as the striker approaches the striking pin.

5. The striking mechanism device as claimed in claim 4, wherein the insertion recess is configured as a blind hole.

6. The striking mechanism device as claimed in claim 4, wherein the insertion recess is of a depth that is at least greater than 10% of a total extent of the striker along a direction oriented contrary to a striking direction of the striker.

7. A portable power tool, comprising:
a striking mechanism device including:
at least one striker;
at least one striking pin having at least one guide lug facing toward the striker; and
at least one movably mounted control disc disposed around the guide lug,
wherein one end of the guide lug projects beyond the control disc in each operating state.

8. The striking mechanism device as claimed in claim 1, wherein the striking mechanism device is configured for one or more of a hammer drill and a chipping hammer.

9. The portable power tool as claimed in claim 7, wherein the portable power tool is configured as one or more of a hammer drill and a chipping hammer.
